(19) United States
(12) Patent Application Publication
(10) Pub. No.: US 2015/0115852 A1
(43) Pub. Date: Apr. 30, 2015

(54) OVER-CURRENT PROTECTION CIRCUIT AND MOTOR DRIVING DEVICE

(71) Applicant: SAMSUNG ELECTRO-MECHANICS CO., LTD., Suwon-Si (KR)

(72) Inventor: Soo Woong LEE, Suwon-Si (KR)

(21) Appl. No.: 14/244,450

(22) Filed: Apr. 3, 2014

(30) Foreign Application Priority Data
Oct. 30, 2013 (KR) 10-2013-0129742

(51) Int. Cl. H02H 7/122

(52) U.S. Cl. CPC H02H 7/1225
USPC 318/400.22

(57) ABSTRACT

An over-current protection circuit may include a preliminary driving unit driving a motor inverter in a start-up mode prior to a normal mode, a current level detecting unit detecting a level of a current flowing through the motor inverter and a motor according to driving of the motor inverter and providing a detection voltage, and an over-current reference voltage setting unit setting the detection voltage detected by the current level detecting unit as an over-current reference voltage in the start-up mode.

### CROSS-REFERENCE TO RELATED APPLICATION

This application claims the benefit of Korean Patent Application No. 10-2013-0129742 filed on Oct. 30, 2013, with the Korean Intellectual Property Office, the disclosure of which is incorporated herein by reference.

### BACKGROUND

The present disclosure relates to an over-current protection circuit and a motor driving device.

In general, in order to protect a system from an over-current, high temperatures, or the like, a motor driving device may include a protection circuit such as a current shutdown circuit, a thermal shutdown circuit, or the like.

In order to determine the occurrence of an over-current, an existing motor driving device may compare the level of a current detection signal with the level of a reference signal, and when the level of the detection signal is greater than the level of the reference signal, the motor driving device may determine the occurrence of an over-current. Here, an over-current refers to a current having a level equal to or higher than that of a maximum level of a current possible in a system used therefor. In existing motor driving devices, an over-current reference level may be set in advance.

However, an over-current reference level may vary, according to modeled resistance of a motor, ON resistance of a power switch, or the like. Thus, in a case in which a reference level of a reference signal for determining the occurrence of an over-current is fixed, an over-current reference level may differ, according to characteristics which may change in the case that a motor is replaced, it may be difficult to accurately determine the occurrence of an over-current.

### SUMMARY

Some embodiments of the present disclosure may provide an over-current protection circuit and a motor driving device capable of accurately determining the occurrence of an over-current even in the case that a motor has been replaced, by setting a level of a reference signal for determining the occurrence of an over-current in a start-up mode prior to a normal mode.

According to some embodiments of the present disclosure, an over-current protection circuit may include: a preliminary driving unit configured to drive a motor inverter in a start-up mode prior to a normal mode; a current level detecting unit configured to detect a level of a current flowing through the motor inverter and a motor according to driving of the motor inverter and provide a detection voltage; and an over-current reference voltage setting unit configured to set a level of a detection voltage corresponding to a maximum current level among the detection voltages detected by the current level detecting unit, as an over-current reference voltage in the start-up mode.

The over-current protection circuit may further include a mode identification signal generating unit configured to generate a mode identification signal having a high level in the start-up mode and having a low level in the normal mode following the start-up mode.

The mode identification signal generating unit may include a power-on reset (POR) circuit unit generating the mode identification signal by using a POR signal for resetting an internal register when power is turned on.

The preliminary driving unit may turn on a high side switch element of the motor inverter and a low side switch element of the motor inverter in the start-up mode.

The preliminary driving unit may include a first switch turning one of the high side switch elements of the motor inverter on in the start-up mode; and a second switch turning one of the low side switch elements of the motor inverter on in the start-up mode.

The over-current reference voltage setting unit may include: a comparing unit including a plurality of first to Nth comparators comparing the level of the detection voltage with levels of a plurality of first to nth reference voltages to provide first to Nth comparison signals, the first to Nth comparison signals having a high level when the detection voltage has a higher level than a corresponding reference voltage and having a low level when the detection voltage does not have a higher level than the corresponding reference voltage; a decoder configured to decode the first to Nth comparison signals to provide a digital signal; a reference voltage generating unit configured to generate a reference voltage according to the digital signal from the decoder; and a latch unit configured to maintain the reference voltage from the reference voltage generating unit.

According to some embodiments of the present disclosure, an over-current protection circuit may include: a mode identification signal generating unit configured to generate a mode identification signal identifying a start-up mode and a normal mode; a preliminary driving unit configured to drive a motor inverter before the normal mode, in the start-up mode according to the mode identification signal; a current level detecting unit configured to detect a level of a current flowing through the motor inverter and a motor according to driving of the motor inverter, and provide a detection voltage; an over-current reference voltage setting unit configured to set the detection voltage detected by the current level detecting unit as an over-current reference voltage in the start-up mode according to the mode identification signal; and an over-current detecting unit configured to compare the detection voltage with the over-current reference voltage and detect an over-current in the normal mode according to the mode identification signal.

The mode identification signal generating unit may generate a mode identification signal having a high level in the start-up mode and having a low level in the normal mode following the start-up mode according to the mode identification signal.

The mode identification signal generating unit may include a power-on reset (POR) circuit unit generating the mode identification signal by using a POR signal for resetting an internal register when power is turned on.

The preliminary driving unit may turn on a high side switch element of the motor inverter and a low side switch element of the motor inverter in the start-up mode according to the mode identification signal.

The preliminary driving unit may include a first switch configured to turn one of the high side switch elements of the motor inverter on in the start-up mode according to the mode identification signal; and a second switch configured to turn one of the low side switch elements of the motor inverter on in the start-up mode according to the mode identification signal.

The over-current reference voltage setting unit may include: a comparing unit including a plurality of first to Nth comparators comparing the level of the detection voltage with levels of a plurality of first to nth reference voltages to provide first to Nth comparison signals, the first to Nth comparison signals having a high level when the detection voltage has a higher level than a corresponding reference voltage and having a low level when the detection voltage does not have a higher level than the corresponding reference voltage; a decoder configured to decode the first to Nth comparison signals to provide a digital signal; a reference voltage generating unit configured to generate a reference voltage according to the digital signal from the decoder; and a latch unit configured to maintain the reference voltage from the reference voltage generating unit.

According to some embodiments of the present disclosure, a motor driving device may include: a mode identification signal generating unit configured to generate a mode identification signal identifying a start-up mode and a normal mode; a preliminary driving unit configured to drive a motor inverter before the normal mode, in the start-up mode according to the mode identification signal; a current level detecting unit configured to detect a level of a current flowing through the motor inverter and a motor according to driving of the motor inverter, and provide a detection voltage; an over-current reference voltage setting unit configured to set the detection voltage detected by the current level detecting unit as an over-current reference voltage in the start-up mode according to the mode identification signal; an over-current detecting unit configured to compare the detection voltage with the over-current reference voltage and detect an over-current in the normal mode according to the mode identification signal; and a controller performing shutdown when the over-current detecting unit detects an over-current, while the motor inverter is being controlled in the normal mode according to the mode identification signal.

The mode identification signal generating unit may generate a mode identification signal having a high level in the start-up mode and having a low level in the normal mode according to the mode identification signal.

The mode identification signal generating unit may include a power-on reset (POR) circuit unit generating the mode identification signal by using a POR signal for resetting an internal register when power is turned on.

The preliminary driving unit may turn on a high side switch element of the motor inverter and a low side switch element of the motor inverter in the start-up mode according to the mode identification signal.

The preliminary driving unit may include a first switch configured to turn one of the high side switch elements of the motor inverter on in the start-up mode according to the mode identification signal; and a second switch configured to turn one of the low side switch elements of the motor inverter on in the start-up mode according to the mode identification signal.

The over-current reference voltage setting unit may include: a comparing unit including a plurality of first to Nth comparators comparing the level of the detection voltage with levels of a plurality of first to nth reference voltages to provide first to Nth comparison signals, the first to Nth comparison signals having a high level when the detection voltage has a higher level than a corresponding reference voltage and having a low level when the detection voltage does not have a higher level than the corresponding reference voltage; a decoder configured to decode the first to Nth comparison signals to provide a digital signal; a reference voltage generating unit configured to generate a reference voltage according to the digital signal from the decoder; and a latch unit configured to maintain the reference voltage from the reference voltage generating unit.

According to some embodiments of the present disclosure, a motor driving device may include: a mode identification signal generating unit configured to generate a mode identification signal identifying a start-up mode and a normal mode by using a power-on-reset (POR) signal for resetting an internal register when power is turned on; a preliminary driving unit configured to turn on a high side switch element of the motor inverter and a low side switch element of the motor inverter to drive the motor inverter in the case of the start-up mode according to the mode identification signal; a current level detecting unit configured to detect a level of a current flowing through the motor inverter and a motor according to driving of the motor inverter, and provide a detection voltage; an over-current reference voltage setting unit configured to set the detection voltage detected by the current level detecting unit as an over-current reference voltage in the start-up mode according to the mode identification signal; an over-current detecting unit configured to compare the detection voltage with the over-current reference voltage and detecting an over-current in the normal mode according to the mode identification signal; and a controller configured to perform shutdown when the over-current detecting unit detects an over-current, while the motor inverter is being controlled in the normal mode according to the mode identification signal.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a view illustrating an over-current protection circuit according to an exemplary embodiment of the present disclosure;

FIG. 2 is a view illustrating a motor driving device according to an exemplary embodiment of the present disclosure;

FIG. 3 is a view illustrating a mode identification signal generating unit according to an exemplary embodiment of the present disclosure;

FIG. 4 is a view illustrating a preliminary driving unit according to an exemplary embodiment of the present disclosure;

FIG. 5 is a view illustrating a preliminary driving unit according to another exemplary embodiment of the present disclosure;

FIG. 6 is a view illustrating an operation of the preliminary driving unit of FIG. 4 in a start-up mode;

FIG. 7 is a view illustrating an operation of the preliminary driving unit of FIG. 4 in a normal mode;

FIG. 8 is a view illustrating an over-current reference voltage setting unit according to an exemplary embodiment of the present disclosure;

FIG. 9 is a view illustrating an operation of the over-current reference voltage setting unit according to an exemplary embodiment of the present disclosure; and

FIG. 10 is a view illustrating an over-current detecting unit according to an exemplary embodiment of the present disclosure.

### DETAILED DESCRIPTION

Hereinafter, embodiments of the present disclosure will be described in detail with reference to the accompanying drawings. The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art. Throughout the drawings, the same or like reference numerals will be used to designate the same or like elements.

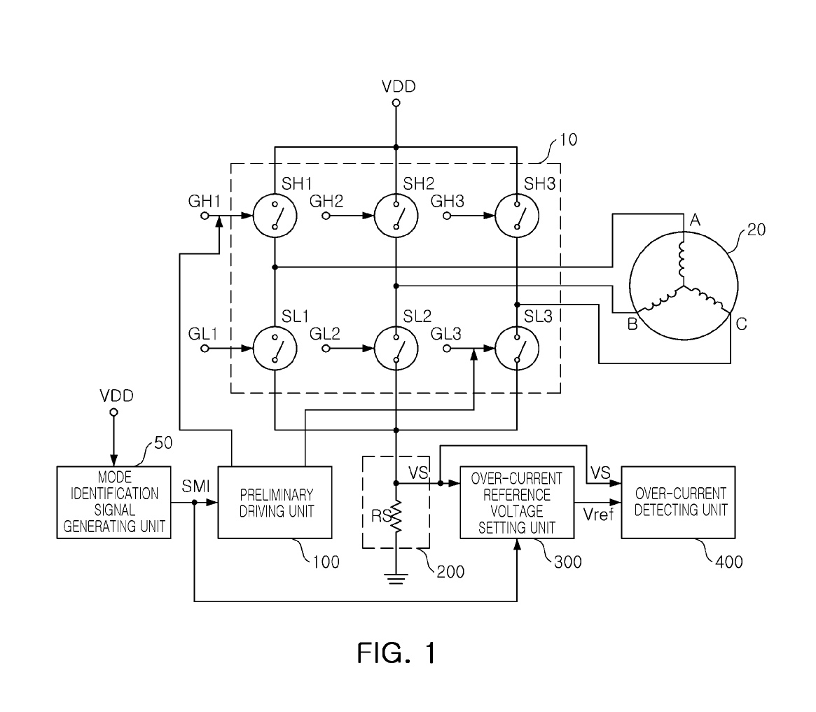

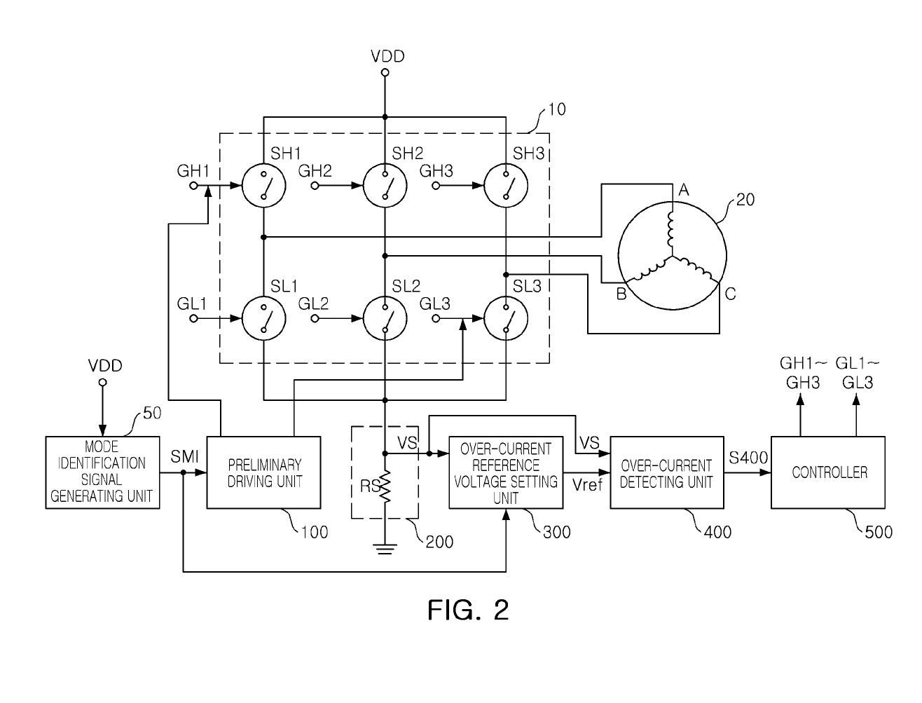

FIG. 1 is a view illustrating an over-current protection circuit according to an exemplary embodiment of the present disclosure, and FIG. 2 is a view illustrating a motor driving device according to an exemplary embodiment of the present disclosure.

Referring to FIG. 1, an over-current protection circuit according to the exemplary embodiment of the present disclosure may include a preliminary driving unit 100, a current level detecting unit 200, and an over-current reference voltage setting unit 300.

Also, the over-current protection circuit according to the exemplary embodiment of the present disclosure may further include a mode identification signal generating unit 50 and an over-current detecting unit 400.

Referring to FIG. 2, a motor driving device according to the exemplary embodiment of the present disclosure may include a mode identification signal generating unit 50, a preliminary driving unit 100, a current level detecting unit 200, an over-current reference voltage setting unit 300, and an over-current detecting unit 400.

Also, the motor driving device according to the exemplary embodiment of the present disclosure may further include a controller 500.

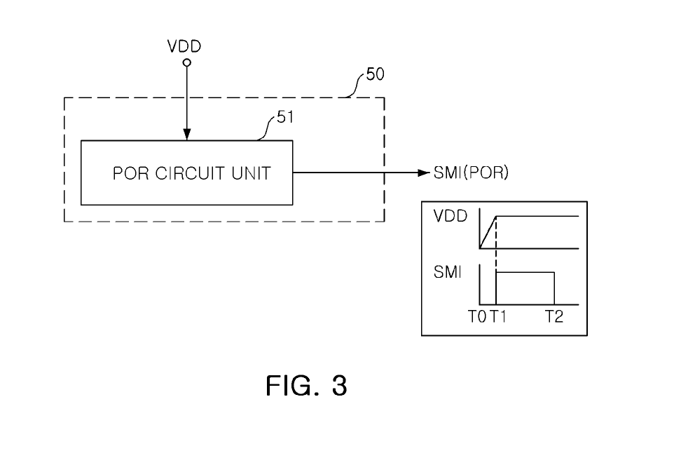

Referring to FIGS. 1 and 2, the mode identification signal generating unit 50 may generate a mode identification signal (SMI) identifying a start-up mode and a normal mode. Here, the start-up mode, a mode prior to the normal mode, indicates a duration from a point in time (T1 in FIG. 3) at which a source voltage starts to be supplied to a point in time (T2 in FIG. 3) at which a motor enters the normal mode in which the motor is driven normally.

For example, the mode identification signal generating unit 50 may generate a mode identification signal SMI having a high level in the start-up mode and a low level in the normal mode following the start-up mode.

Here, the levels of the mode identification signal SMI may be reversed according to an environment of an application system.

In the start-up mode according to the mode identification signal SMI, the preliminary driving unit 100 may drive a motor inverter 10 before the normal mode.

For example, the motor inverter 10 is not driven in the start-up mode, and thus, in order to measure a current flowing through a motor, the motor inverter 10 may be temporarily driven.

According to the driving of the motor inverter 10, the current level detecting unit 200 may detect a current flowing through the motor inverter 10 and the motor 20 and provide a detection voltage VS.

For example, the current level detecting unit 200 may include a detection resistor RS connected between the motor inverter 10 and a ground. Thus, when a detection current IS flows in the detection resistor RS, the current level detecting unit 200 may detect the detection voltage (VS=RS*IS).

In the start-up mode according to the mode identification signal SMI, the over-current reference voltage setting unit 300 may set the detection voltage VS detected by the current level detecting unit 200 as a reference voltage Vref of an over-current.

Here, the detection voltage VS is a voltage corresponding to a maximum current ISmax. This will be described later.

In the normal mode according to the mode identification signal SMI, the over-current detecting unit 400 may compare the reference voltage Vref of the over-current with the detection voltage VS to detect an over-current.

Referring to FIG. 2, while the controller 500 is controlling the motor inverter 10 in the normal mode according to the mode identification signal SMI, when the over-current detecting unit 400 detects an over-current, the controller 500 may perform over-current shut-down.

FIG. 3 is a view illustrating a mode identification signal generating unit according to an exemplary embodiment of the present disclosure.

Referring to FIG. 3, the mode identification signal generating unit 50 may include a power-on-reset (POR) circuit unit 51.

The POR circuit unit 51 may generate the mode identification signal SMI by using a POR signal for resetting an internal register in the event of power-ON.

In this case, the POR signal has a high level in the duration from the point in time T1 a short while after a point in time T0 at which the source voltage VDD is applied, to the pre-set time T2. Accordingly, while the source voltage VDD is being supplied, when the POR signal has a high level, a start-up mode may be recognized, and when the POR signal has a low level, the normal mode may be recognized.

Meanwhile, as illustrated in FIGS. 1 and 2, in the case of driving a 3-phase motor, the motor inverter 10 may include three high side switch elements SH1, SH2, and SH3 and three low side switch elements SL1, SL2, and SL3. In this case, the three high side switch elements SH1, SH2, and SH3 may be operated by high side gate signals GH1-GH3, and the three low side switch elements SL1, SL2, and SL3 may be operated by low side gate signals GL1-GL3.

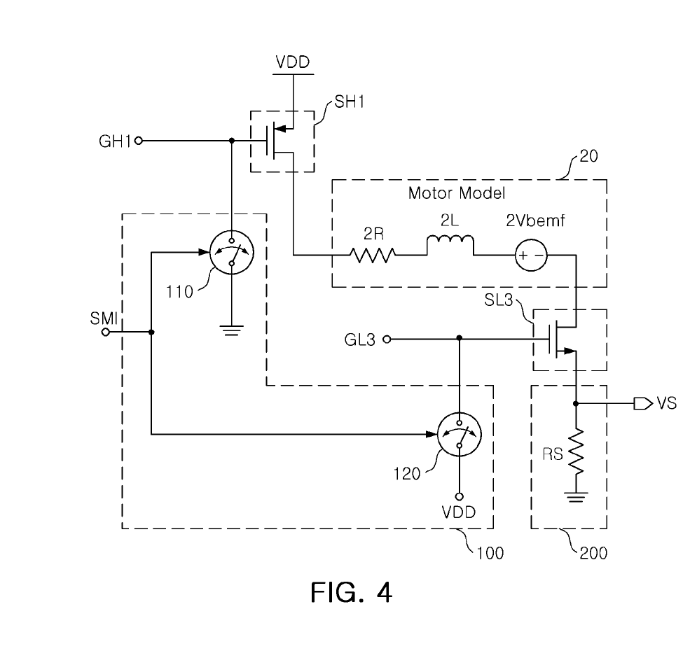

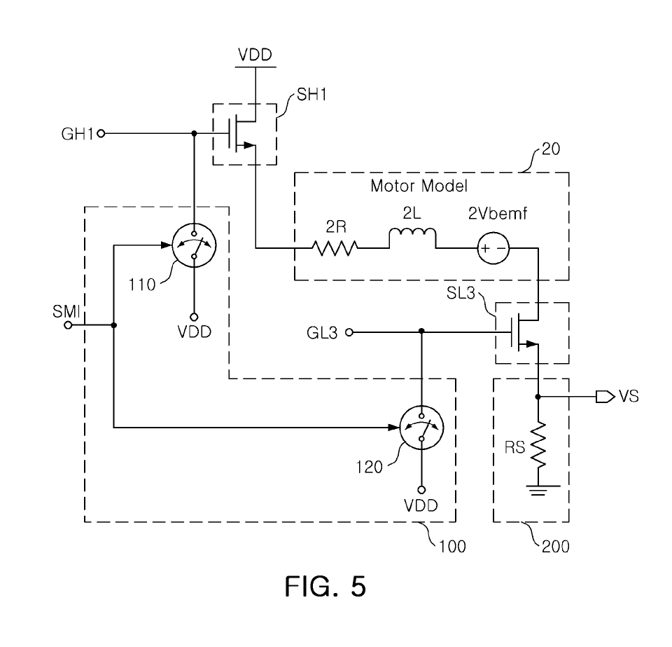

In this case, the preliminary driving unit 100 may turn on one of the high side switch elements SH1, SH2, and SH3 of the motor inverter 10 and one of the low side switch elements SL1, SL2, and SL3 of the motor inverter 10, in the start-up mode. This will be described with reference to FIGS. 4 and 5.

FIG. 4 is a view illustrating a preliminary driving unit according to an exemplary embodiment of the present disclosure, and FIG. 5 is a view illustrating a preliminary driving unit according to another exemplary embodiment of the present disclosure.

Referring to FIGS. 1, 4, and 5, the preliminary driving unit 100 may include a first switch 110 and a second switch 120 to temporarily drive the motor inverter 10.

Here, the first switch 110 may turn on one of the high side switch elements SH1, SH2, and SH3 of the motor inverter 10 in the start-up mode. Also, the second switch 120 may turn on one of the low side switch elements SL1, SL2, and SL3 of the motor inverter 10 in the start-up mode.

When one high side switch element and one low side switch element are turned on, current flows in the motor inverter.

For example, as illustrated in FIGS. 1, 4, and 5, the first switch 110 may turn on the first high side switch element SH1 among the high side switch elements SH1, SH2, and SH3, and the second switch 120 may turn on the third low side switch element SL3 among the low side switch elements SL1, SL2, and SL3.

Referring to FIG. 4, in a case in which the first high side switch element SH1 is a PMOS transistor and the third low side switch element SL3 is an NMOS transistor, the first switch 110 may be connected between a gate of the first high side switch element SH1, the PMOS transistor, and a ground, and the second switch 120 may be connected to a gate of the third low side switch element SL3, the NMOS transistor, and the source voltage VDD terminal.

The first switch 110 and the second switch 120 are semiconductor switch elements. For example, a PMOS transistor or an NMOS transistor may be applied to the first switch 110 and the second switch 120. Hereinafter, in the exemplary embodiment of the present disclosure, the first switch 110 and the second switch 120 are assumed to be high active elements such as NMOS transistors which are turned on at a high level.

Referring to FIG. 5, in a case in which the first high side switch element SH1 is an NMOS transistor and the third low side switch element SL3 is an NMOS transistor, the first switch 110 may be connected between a gate of the first high side switch element SH1, an NMOS transistor, and the source voltage VDD terminal. The second switch 120 may be connected between a gate of the third low side switch element SL3, an NMOS transistor, and the source voltage VDD terminal.

For example, in a case in which the mode identification signal SMI has a high level in the start-up mode, the first and second switches 110 and 120 are turned on, and the first high side switch element SH1 and the third low side switch element SL3 may subsequently be turned on.

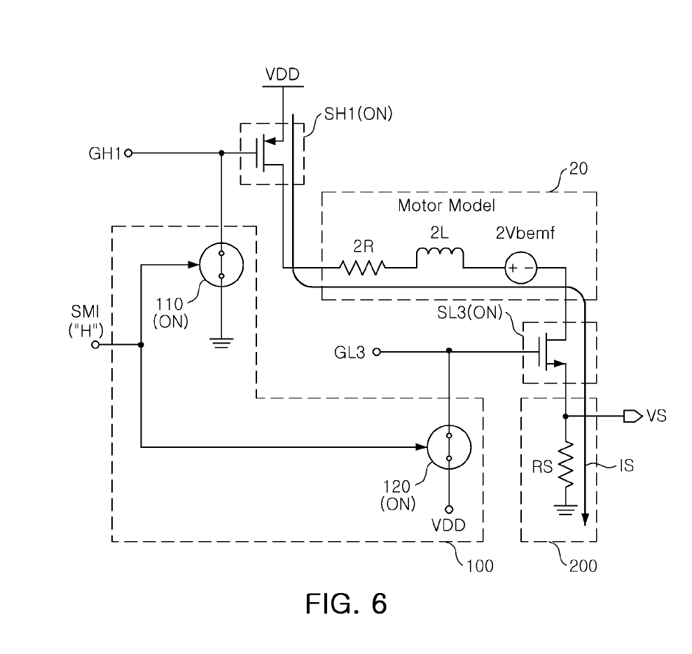

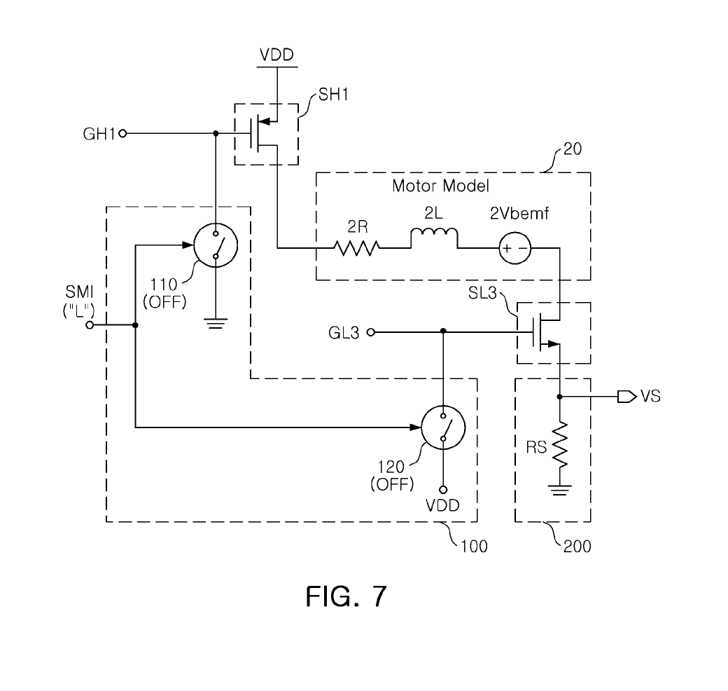

FIG. 6 is a view illustrating an operation of the preliminary driving unit of FIG. 4 in a start-up mode, and FIG. 7 is a view illustrating an operation of the preliminary driving unit of FIG. 4 in a normal mode.

Referring to FIG. 6, when the preliminary driving unit 100 is implemented as illustrated in FIG. 4, in the case of the start-up mode according to the mode identification signal SMI, the first and second switches 110 and 120 of the preliminary driving unit 100 may be turned on.

Accordingly, a ground potential may be applied to the gate of the first high side switch element SH1, a PMOS transistor, through the first switch 110 to turn on the first high side switch element SH1.

Also, a source voltage VDD may be applied to the gate of the third low side switch element SL3, an NMOS transistor, through the second switch 120 to turn on the third low side switch element SL3.

In this case, the detection current IS may flow from the source voltage VDD terminal to the first high side switch element SH1 and the third low side switch element SL3 of the motor inverter 10, the motor 20, and to a ground. In this case, as illustrated in FIG. 4, the motor 20 may be modeled with a resistor 2R, an inductance 2L and a counter electromotive force 2Vbemf.

Here, the source voltage VDD may be equal to a voltage obtained by adding the counter electromotive force Vbemf, resistance ({Ron-SH1}+2R+{Ron-SL3}+RS) between the source voltage VDD terminal and the ground, and a voltage determined by the detection current IS, and it may be expressed by Equation 1 below.

VDD=2Vbemf+IS(Ron−SH1+2R+Ron−SL3+RS)

Here, Ron-SH1 is an ON resistor of the first high side switch element SH1, Ron-SL3 is an ON resistor of the third low side switch element SL3, 2R is a modeled resistor of the motor, and RS is a detection resistor.

Meanwhile, modeled inductance of the motor has negligible resistance with respect to a direct current (DC) current, so it may be omitted in Equation 1.

In Equation 1, it may be noted that the maximum current ISmax flows when the counter electromotive voltage Vbemf is not output yet. For example, the maximum current ISmax may be detected in the start-up mode corresponding to an initial state of the motor prior to the normal mode.

The maximum current ISmax may be expressed by Equation 2 below.

$$ISmax = \frac{VDD}{( Ron - SH 1 + 2 R + Ron - SL 3 + RS )} \qquad [ Equation 2 ]$$

Referring to FIG. 7, when the preliminary driving unit 100 is implemented as illustrated in FIG. 4, in the case of the normal mode according to the mode identification signal SMI, the first and second switches 110 and 120 of the preliminary driving unit 100 may be turned off.

Accordingly, the first high side switch element SH1 and the third low side switch element SL3 may be operated, by the corresponding gate signals GH1 and GL3 in the normal mode, respectively.

For example, in the normal mode, the controller 500 may provide the high side gate signals GH1 to GH3 and the low side gate signals GL1˜GL3 to the motor inverter 10 to control the motor inverter 10.

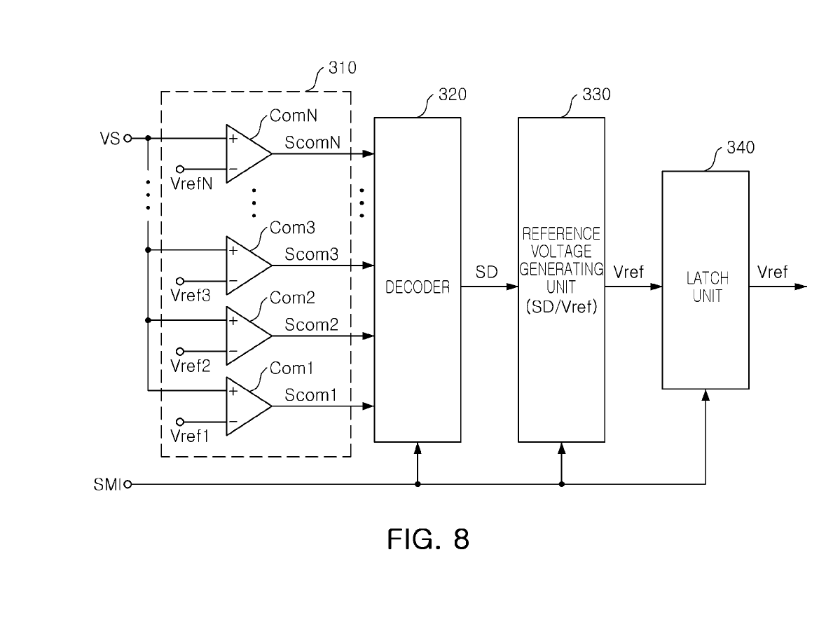

FIG. 8 is a view illustrating an over-current reference voltage setting unit according to an exemplary embodiment of the present disclosure.

Referring to FIG. 8, the over-current reference voltage setting unit 300 may include a comparing unit 310, a decoder 320, a reference voltage generating unit 330, and a latch unit 340.

The comparing unit 310 may include first to Nth comparators Com1˜ComN comparing the detection voltage VS with a plurality of first to nth reference voltages Vref1˜VrefN and providing first to Nth comparison signals Scom1˜ScomN. The first to Nth comparators Com1˜ComN may provide the first to Nth comparison signals Scom1˜ScomN having a high level when the detection voltage VS has a level higher than that of the corresponding reference voltage or having a low level when the detection voltage VS is not higher than the corresponding reference voltage, respectively.

The decoder 320 may decode the first to Nth comparison signals Com1˜ComN to provide a digital signal SD. Here, the decoder 320 may provide the digital signal SD having the number of bits that may be expressed in all of the first to Nth comparison signals Com1˜ComN.

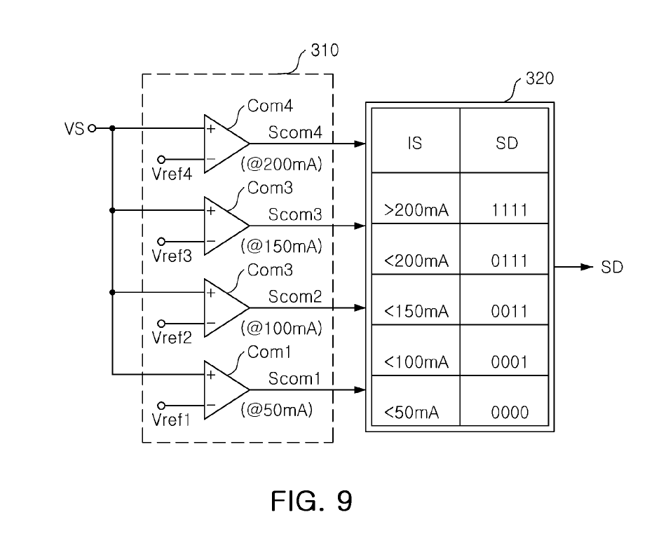

For example, the decoder 320 may have a table in which digital signals SD having a bit value corresponding to each of the first to Nth comparison signals Com1˜ComN are pre-set and matched. This will be described with reference to FIG. 9.

The reference voltage generating unit 330 may generate a reference voltage Vref according to the digital signal SD from the decoder 320.

For example, the reference voltage generating unit 330 may include a table of a plurality of reference voltages Vref matched to a plurality of digital signals SD and provide a reference voltage Vref matched to the digital signal SD provided differently according to the detected maximum current ISmax (ISmax is equal to IS in the start-up mode).

On the other hand, the decoder 320 and the reference voltage generating unit 330 may receive the mode identification signal SMI as an enabling signal, and in this case, the decoder 320 and the reference voltage generating unit 330 may be enabled in the start-up mode and disabled in the normal mode according to the mode identification signal SMI.

The latch unit 340 may maintain the reference voltage Vref from the reference voltage generating unit 330.

For example, in the case of the start-up mode according to the mode identification signal SMI, the latch unit 340 may receive the reference voltage Vref from the reference voltage generating unit 330 and provide the reference voltage Vref.

Meanwhile, in the case of the normal mode according to the mode identification signal SMI, the latch unit 340 may maintain the previous reference voltage Vref, rather than receiving the reference voltage Vref from the reference voltage generating unit 330.

FIG. 9 is a view illustrating an operation of the over-current reference voltage setting unit according to an exemplary embodiment of the present disclosure.

Referring to FIG. 9, a comparing unit 310 of the over-current reference voltage setting unit 300 may include first to fourth comparators Com1˜ComN comparing the detection voltage VS with the first to fourth reference voltages Vref1˜Vref4 and providing first to fourth comparison signals Scom1˜Scom4, respectively.

The first to fourth comparators Com1˜ComN may provide first to fourth comparison signals Scom1˜Scom4 having a high level when the detection voltage VS has a level higher than that of the corresponding reference voltage, and having a low level when the detection voltage VS has a level lower than that of the corresponding reference voltage, respectively.

For example, when the detection voltage VS has a level lower than that of the first reference voltage Vref1 (for example, a voltage corresponding to 50 mA), all of the first to fourth comparators Com1˜Com4 may output first to fourth comparison signals Scom1˜Som4 having a low level.

Alternatively, when the detection voltage VS has a level higher than that of the first reference voltage Vref1 and lower than the second reference voltage Vref2 (for example, a voltage corresponding to 100 mA), only the first comparison signal Scom1 has a high level by the first comparator Com1, while the second to fourth comparison signals Scom2˜Scom4 have a low level.

Alternatively, when the detection voltage VS has a level higher than that of the second reference voltage Vref2 and lower than the third reference voltage Vref3 (for example, a voltage corresponding to 150 mA), the first and second comparison signals Scom1 and Scom2 have a high level by the first and second comparators Com1 and Com2, while the third and fourth comparison signals Scom3 and Scom4 have a low level.

Alternatively, when the detection voltage VS has a level higher than that of the third reference voltage Vref3 and lower than the fourth reference voltage Vref4 (for example, a voltage corresponding to 200 mA), the first to third comparison signals Scom1˜Scom3 have a high level by the first to third comparators Com1˜Com3, while the fourth comparison signal Scom4 has a low level.

When the detection voltage VS has a level higher than that of the fourth reference voltage Vref4, all of the first to fourth comparison signals Scom1˜Scom4 have a low level by the first to fourth comparators Com1˜Com4.

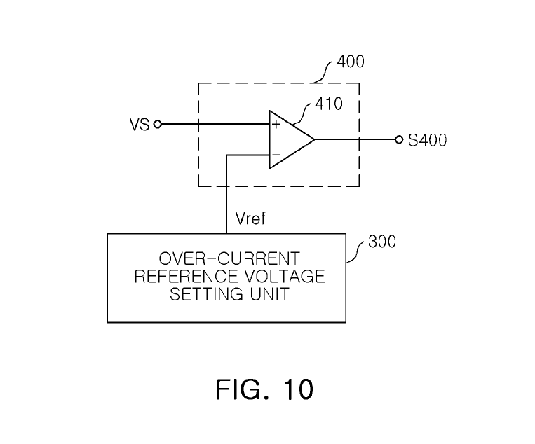

FIG. 10 is a view illustrating an over-current detecting unit according to an exemplary embodiment of the present disclosure.

Referring to FIG. 10, the over-current detecting unit 400 may include an operational amplifier 410 having a non-inverting input terminal receiving the detection voltage VS, an inverting input terminal receiving the reference voltage Vref of over-current, and an output terminal comparing the reference voltage Vref of over-current with the detection voltage VS and outputting a signal corresponding to the comparison in the normal mode according to the mode identification signal SMI.

When the detection voltage VS has a level higher than that of the reference voltage Vref of over-current, the operational amplifier 410 may provide a signal having a high level indicating detection of an over-current to the controller 500.

According to exemplary embodiments of the present disclosure, by setting a level of a reference signal for determining the occurrence of an over-current in a start-up mode before a normal mode, an over-current may be accurately determined even in the case that a motor has been replaced.

While exemplary embodiments have been shown and described above, it will be apparent to those skilled in the art that modifications and variations could be made without departing from the spirit and scope of the present disclosure as defined by the appended claims.

What is claimed is:

1. An over-current protection circuit, comprising:
a preliminary driving unit configured to drive a motor inverter in a start-up mode prior to a normal mode;
a current level detecting unit configured to detect a level of a current flowing through the motor inverter and a motor according to driving of the motor inverter and provide a detection voltage; and
an over-current reference voltage setting unit configured to set the detection voltage detected by the current level detecting unit as an over-current reference voltage in the start-up mode.

2. The over-current protection circuit of claim 1, further comprising a mode identification signal generating unit configured to generate a mode identification signal having a high level in the start-up mode and having a low level in the normal mode following the start-up mode.

3. The over-current protection circuit of claim 2, wherein the mode identification signal generating unit includes a power-on reset (POR) circuit unit generating the mode identification signal by using a POR signal for resetting an internal register when power is turned on.

4. The over-current protection circuit of claim 1, wherein the preliminary driving unit turns on a high side switch element of the motor inverter and a low side switch element of the motor inverter in the start-up mode.

5. The over-current protection circuit of claim 1, wherein the preliminary driving unit includes:
a first switch configured to turn one of the high side switch elements of the motor inverter on in the start-up mode; and
a second switch configured to turn one of the low side switch elements of the motor inverter on in the start-up mode.

6. The over-current protection circuit of claim 1, wherein the over-current reference voltage setting unit comprises:
a comparing unit including a plurality of first to Nth comparators comparing the level of the detection voltage with levels of a plurality of first to nth reference voltages to provide first to Nth comparison signals, the first to Nth comparison signals having a high level when the detection voltage has a higher level than a corresponding reference voltage and having a low level when the detection voltage does not have a higher level than the corresponding reference voltage;
a decoder configured to decode the first to Nth comparison signals to provide a digital signal;
a reference voltage generating unit configured to generate a reference voltage according to the digital signal from the decoder; and
a latch unit configured to maintain the reference voltage from the reference voltage generating unit.

7. An over-current protection circuit, comprising:
a mode identification signal generating unit configured to generate a mode identification signal identifying a start-up mode and a normal mode;
a preliminary driving unit configured to drive a motor inverter before the normal mode, in the start-up mode according to the mode identification signal;
a current level detecting unit configured to detect a level of a current flowing through the motor inverter and a motor according to driving of the motor inverter, and provide a detection voltage;
an over-current reference voltage setting unit configured to set the detection voltage detected by the current level detecting unit as an over-current reference voltage in the start-up mode according to the mode identification signal; and
an over-current detecting unit configured to compare the detection voltage with the over-current reference voltage and detecting an over-current in the normal mode according to the mode identification signal.

8. The over-current protection circuit of claim 7, wherein the mode identification signal generating unit generates a mode identification signal having a high level in the start-up mode and having a low level in the normal mode following the start-up mode according to the mode identification signal.

9. The over-current protection circuit of claim 7, wherein the mode identification signal generating unit includes a power-on reset (POR) circuit unit generating the mode identification signal by using a POR signal for resetting an internal register when power is turned on.

10. The over-current protection circuit of claim 7, wherein the preliminary driving unit turns on a high side switch element of the motor inverter and a low side switch element of the motor inverter on in the start-up mode according to the mode identification signal.

11. The over-current protection circuit of claim 7, wherein the preliminary driving unit includes:
a first switch configured to turn one of the high side switch elements of the motor inverter on in the start-up mode according to the mode identification signal; and
a second switch configured to turn one of the low side switch elements of the motor inverter on in the start-up mode according to the mode identification signal.

12. The over-current protection circuit of claim 7, wherein the over-current reference voltage setting unit includes:
a comparing unit including a plurality of first to Nth comparators comparing the level of the detection voltage with levels of a plurality of first to nth reference voltages to provide first to Nth comparison signals, the first to Nth comparison signals having a high level when the detection voltage has a higher level than a corresponding reference voltage and having a low level when the detection voltage does not have a higher level than the corresponding reference voltage;
a decoder configured to decode the first to Nth comparison signals to provide a digital signal;
a reference voltage generating unit configured to generate a reference voltage according to the digital signal from the decoder; and
a latch unit configured to maintain the reference voltage from the reference voltage generating unit.

13. A motor driving device, comprising:
a mode identification signal generating unit configured to generate a mode identification signal identifying a start-up mode and a normal mode;
a preliminary driving unit configured to drive a motor inverter before the normal mode, in the start-up mode according to the mode identification signal;
a current level detecting unit configured to detect a level of a current flowing through the motor inverter and a motor according to driving of the motor inverter, and provide a detection voltage;
an over-current reference voltage setting unit configured to set the detection voltage detected by the current level detecting unit as an over-current reference voltage in the start-up mode according to the mode identification signal;
an over-current detecting unit configured to compare the detection voltage with the over-current reference voltage and detecting an over-current in the normal mode according to the mode identification signal; and
a controller configured to perform shutdown when the over-current detecting unit detects an over-current, while the motor inverter is being controlled in the normal mode according to the mode identification signal.

14. The motor driving device of claim 13, wherein the mode identification signal generating unit generates a mode identification signal having a high level in the start-up mode and having a low level in the normal mode according to the mode identification signal.

15. The motor driving device of claim 13, wherein the mode identification signal generating unit includes a power-on reset (POR) circuit unit generating the mode identification signal by using a POR signal for resetting an internal register when power is turned on.

16. The motor driving device of claim 13, wherein the preliminary driving unit turns on a high side switch element of the motor inverter and a low side switch element of the motor inverter in the start-up mode according to the mode identification signal.

17. The motor driving device of claim 13, wherein the preliminary driving unit includes:
a first switch configured to turn one of the high side switch elements of the motor inverter on in the start-up mode according to the mode identification signal; and
a second switch configured to turn one of the low side switch elements of the motor inverter on in the start-up mode according to the mode identification signal.

18. The motor driving device of claim 13, wherein the over-current reference voltage setting unit comprises:
a comparing unit including a plurality of first to Nth comparators comparing the level of the detection voltage with levels of a plurality of first to nth reference voltages to provide first to Nth comparison signals, the first to Nth comparison signals having a high level when the detection voltage has a higher level than a corresponding reference voltage and having a low level when the detection voltage does not have a higher level than the corresponding reference voltage;
a decoder configured to decode the first to Nth comparison signals to provide a digital signal;
a reference voltage generating unit configured to generate a reference voltage according to the digital signal from the decoder; and
a latch unit configured to maintain the reference voltage from the reference voltage generating unit.

19. A motor driving device, comprising:
a mode identification signal generating unit configured to generate a mode identification signal identifying a start-up mode and a normal mode by using a power-on-reset (POR) signal for resetting an internal register when power is turned on;
a preliminary driving unit configured to turn a high side switch element of the motor inverter and a low side switch element of the motor inverter on to drive the motor inverter in the case of the start-up mode according to the mode identification signal;
a current level detecting unit configured to detect a level of a current flowing through the motor inverter and a motor according to driving of the motor inverter, and provide a detection voltage;
an over-current reference voltage setting unit configured to set the detection voltage detected by the current level detecting unit as an over-current reference voltage in the start-up mode according to the mode identification signal;
an over-current detecting unit configured to compare the detection voltage with the over-current reference voltage and detect an over-current in the normal mode according to the mode identification signal; and
a controller configured to perform shutdown when the over-current detecting unit detects an over-current, while the motor inverter is being controlled in the normal mode according to the mode identification signal.

20. The motor driving device of claim 19, wherein the over-current reference voltage setting unit includes:
a comparing unit including a plurality of first to Nth comparators comparing the level of the detection voltage with levels of a plurality of first to nth reference voltages to provide first to Nth comparison signals, the first to Nth comparison signals having a high level when the detection voltage has a higher level than a corresponding reference voltage and having a low level when the detection voltage does not have a higher level than the corresponding reference voltage;
a decoder configured to decode the first to Nth comparison signals to provide a digital signal;
a reference voltage generating unit configured to generate a reference voltage according to the digital signal from the decoder; and
a latch unit configured to maintain the reference voltage from the reference voltage generating unit.
